(19) United States
(12) Patent Application Publication
(10) Pub. No.: US 2007/0062027 A1
(43) Pub. Date: Mar. 22, 2007

(54) INDUCTIVE STRUCTURE

(75) Inventors: Giancarlo Ripamonti, Milano (IT); Paolo Pulici, Legnano (IT); Gian Pietro Vanalli, Almenno San Bartolomeo (IT); Tito Lessio, Cinisello B.mo (IT); Pier Paolo Stoppino, Milano (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS S.R.L., Agrate Brianza (IT)

(21) Appl. No.: 11/530,320

(22) Filed: Sep. 8, 2006

(30) Foreign Application Priority Data
Sep. 9, 2005 (EP) 05425635.9

(51) Int. Cl. H01F 7/06; H01F 5/00

(52) U.S. Cl. 29/602.1; 336/200

(57) ABSTRACT

An inductive structure having at least one winding or at least one coil and developed around a ferromagnetic core. Advantageously, the ferromagnetic core is formed by means of a multilayer ferromagnetic structure and the inductive structure is integrated in an electronic device. An inductor, a transformer, a sensor and a relay can be formed by means of the inductive structure proposed, as well as a method for integrating it in a package of an electronic device.

### BACKGROUND OF THE INVENTION

1. Field of Invention

The present disclosure relates to inductive structures of the type having at least a winding with at least a coil developed around a ferromagnetic core, to a method for integrating an inductive structure in an electronic device package, and to a multichip device utilizing the inductive structure.

2. Description of the Related Art

As is well known, the progress of integration has had a key role during the last years in the field of electronics. In particular, the need of increasing the potential of an electronic apparatus without increasing the physical magnitude of the object comprising it has pushed, first of all, to reduce the geometric dimensions characteristic of the electronic devices in general (such as for example the channel length of MOSFET transistors).

Three-dimension circuit solutions have also been proposed, in particular exploiting the z dimension of electronic devices integrated in a chip or die, i.e., a dimension orthogonal to a development plane of the chip, by packing, one above the other, more dices and leading to the emergence of the so called stacked devices or multichip.

The market needs and new technological knowledge have enabled realization, by exploiting both the above indicated solutions, i.e., the reduction of the geometric dimensions of the devices and their arrangement according to the z dimension, of real systems inside the same package of an integrated device, the so called Systems in Package, hereafter indicated with SIP.

It is also known that, in the field of multichip devices and of SIP, in case the application had required an inductor of considerable value (higher than some nH), constructors of the multichip device or SIP have provided, up to now, the use of an external discrete component suitably connected by the final user by means of an external PCB, with subsequent increase in the dimensions and the complexity of construction and use of the device itself.

In fact, the discrete inductors on sale with significant saturation currents (higher than 0.5 A) and with inductance value around μH have such dimensions that they cannot be integrated in a SIP. Generally, when the final thickness dimensions are particularly narrow (lower than 1.5 mm), the discrete components, so as to be integrated in a package, must have greatest dimensions equal to a SMD0402 (0.5 mm×1 mm and 0.5 mm of thickness) thus with thickness lower than 700 μm. The discrete inductors with inductance values in the order of the tens of μH and with saturation currents higher than 0.5 A have instead thickness higher than 1 mm.

In the field the need is thus strongly felt of realizing an inductor with considerable inductance value (in particular, higher than some nH) directly integrated in a package of an integrated circuit for realizing a multichip device, such as a stacked device or a SIP.

A known technical solution to meet this need is described in U.S. Pat. No. 6,775,901, granted on Aug. 17, 2004, in the name of Hai Young Lee et al.

Such a document describes an inductor realized with the bonding wires due to the presence of pairs of bonding terminals or pads realized on a substrate of a semiconductor device and of one or more bonding wires configured so as to form a ring and thus an inductive winding. An injection step is also provided for using an epoxy resin to complete the package containing the inductor.

Although advantageous under several aspects, this solution shows some drawbacks. For example, it is immediately evident that the inductor thus realized has a non-confined magnetic field, jeopardizing the operation of the integrated system wherein it is implemented.

The technical problem underlying the present disclosure is that of devising an integrated inductive structure having such structural and functional characteristics as to realize geometric structures of electronic components integrated in a multichip and which use the magnetic properties of one or more coils, simultaneously overcoming the limits and the drawbacks still affecting the devices formed according to prior designs.

### BRIEF SUMMARY OF THE INVENTION

The disclosed embodiments are directed to a winding around a ferromagnetic core having a multilayer structure of a ferromagnetic material deposited on a package substrate of a multichip device, such as for example an SIP or a stacked device. In particular, the winding includes at least a coil realized by exploiting the bonding wires or the tracks of a first metallization layer of the package substrate of the multichip device.

In accordance with one embodiment disclosed herein, an inductive structure is provided that includes at least one winding having at least one coil and developed around a ferromagnetic core, the inductive structure integrated in a package of an electronic device, the ferromagnetic core formed by means of a ferromagnetic structure arranged above a substrate of the package.

In accordance with another aspect of the foregoing embodiment, the ferromagnetic structure is formed of multiple layers that include a plurality of layers of flat ferromagnetic material overlapped onto each other and separated by intervening layers of insulating material that is preferably an adhesive material.

In accordance with another aspect of the foregoing embodiment, the multilayer ferromagnetic structure has a closed configuration that is shaped substantially in the form of a ring.

In accordance with another embodiment of the invention, a circuit is provided, that circuit including a ferromagnetic core formed from a plurality of ferromagnetic layers disposed between layers of adhesive material in an integrated structure; and at least one coil of electrically conductive material formed around the ferromagnetic core, the circuit formed above a substrate of an integrated electronic device.

A method for integrating an inductive structure is provided in accordance with another embodiment in which the inductive structure is integrated on a package substrate that includes providing a package substrate; forming in the package substrate at least one metallization line; integrating on the package substrate at least one electronic device; forming on the package substrate an inductive structure next to the electronic device by depositing a multilayer ferromagnetic structure on the package substrate next to the electronic device, and forming at least one coil of a winding of the integrated inductive structure by means of an electric connection of a portion of the metallization line.

In accordance with another aspect of the foregoing method, the electric connection of a portion of the metallization line includes bonding a first end and a second end of one portion of the metallization line above the multilayer ferromagnetic structure.

In accordance with another aspect of the foregoing method, a coating step is included that includes coating the multilayer ferromagnetic structure with an insulating layer, preferably involving a lower face of the multilayer ferromagnetic structure arranged next to the package substrate and an upper face thereof that is opposite to the lower face.

In accordance with another aspect of this method, the coating step involves all faces of the multilayer ferromagnetic structure.

### BRIEF DESCRIPTION OF THE SEVERAL VIEWS OF THE DRAWINGS

The characteristics and the advantages of the inductive structure according to the invention will be apparent from the following description of an embodiment thereof given by way of indicative and non limiting example with reference to the annexed drawings.

FIG. 1A schematically shows an inductive structure integrated in a multichip device formed according to the present disclosure;

FIG. 1B shows, in greater detail, a detail of the inductive structure of FIG. 1A;

FIG. 2 schematically shows the progress of the magnetic field inside the ferromagnetic material of the inductive structure of FIG. 1A;

FIG. 3 shows, in greater detail, the inductive structure of FIG. 1A;

FIG. 4 schematically shows an application of the inductive structure according to the present disclosure suitable to implement a transformer;

FIG. 5 schematically shows a further application of the inductive structure according to the disclosure suitable to implement an inductive sensor;

FIGS. 6A and 6B schematically show further applications of the inductive structure according to the disclosure suitable to implement an inductive relay;

FIG. 7 schematically shows a further embodiment of a detail of the inductive structure of FIG. 1;

FIG. 8 schematically shows a multichip device equipped with an inductive structure realized according to the present disclosure.

### DETAILED DESCRIPTION OF A REPRESENTATIVE EMBODIMENT

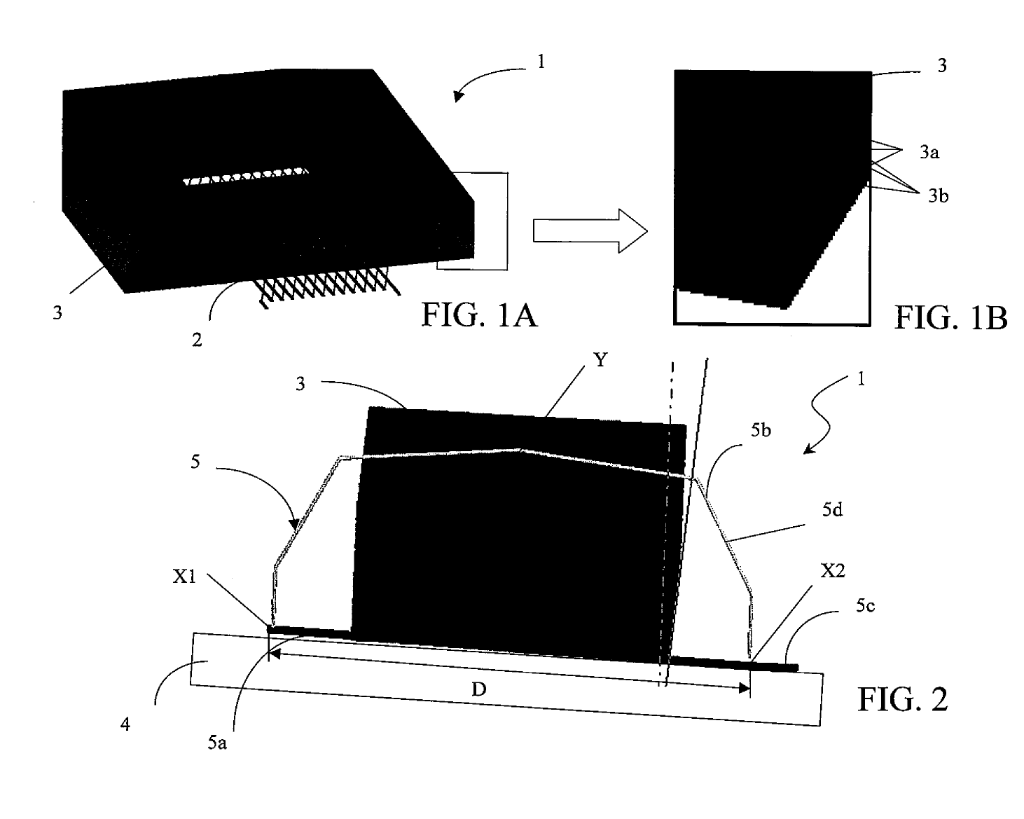

With reference to these figures, and in particular to FIG. 1, 1 globally and schematically indicates an inductive structure formed in accordance with the present disclosure.

In particular, the inductive structure 1 comprises a winding 2 developed around a ferromagnetic core 3.

Advantageously according to the invention, the ferromagnetic core 3 is realized by a ferromagnetic structure suitably arranged above a package substrate so as to be contained inside the winding 2, as it will be clarified hereafter in the description, this package comprising besides the inductive structure 1 at least a further electronic device.

Suitably, the ferromagnetic structure is implemented by means of a multilayer 3 obtained by overlapping different layers 3a of flat ferromagnetic material that are glued onto each other, as shown in FIG. 1B, thus obtaining a ferromagnetic core of desired dimensions for the inductive structure 1.

In other words, the multilayer ferromagnetic structure 3 includes an overlapping of layers 3a of flat ferromagnetic material and of layers 3b of insulating material, suitably adhesive, alternated with each other, and easily inserted in an integration process of a multichip device, as it will be clarified hereafter in the description.

Advantageously, because the ferromagnetic band is very thin, a rather accurate control of the final thickness of the torroidal core is possible.

It is to be noted that the multilayer ferromagnetic structure 3 inserted inside the winding 2 confines the magnetic field of the inductive structure 1 and not to notably influence the interconnections close thereto inside a package.

In a preferred embodiment, the multilayer ferromagnetic structure 3 has a closed configuration, substantially ring-shaped, as shown in FIG. 1A. In particular, in the example shown in this figure, the multilayer ferromagnetic structure 3 is substantially a rectangular plate equipped with a central opening, also preferably rectangular.

The multilayer ferromagnetic structure 3 advantageously obtain substantial inductance values for the integrated inductor in the inductive structure 1, and thus it allows its use inside a package for integrated circuits, the multilayer ferromagnetic structure 3 being deposited on a package substrate 4, as shown in greater detail in FIG. 2.

Only by way of example, it is noted that the multilayer ferromagnetic structure 3 utilizes the ferromagnetic material commercially known with the name VITROVAC 6150. This material has relative magnetic mobilities equal to 1300, and in the configuration shown in FIG. 1A it enables implementation of an integrated inductor of 15 μH with saturation currents close to the Ampere.

Since the thickness of the ferromagnetic layers or bands 3a of VITROVAC 6150 is equal to 25 μm, to obtain the multilayer ferromagnetic structure 3 of suitable thickness, different layers of this material have been overlapped, suitably glued to each other.

It is possible to verify that, with a multilayer ferromagnetic structure 3 having a thickness equal to 750 μm, obtained for example by overlapping fifteen layers 3a of ferromagnetic material, as shown in FIG. 1B, an integrated inductor is realized having an inductance value equal to 17.4 μH.

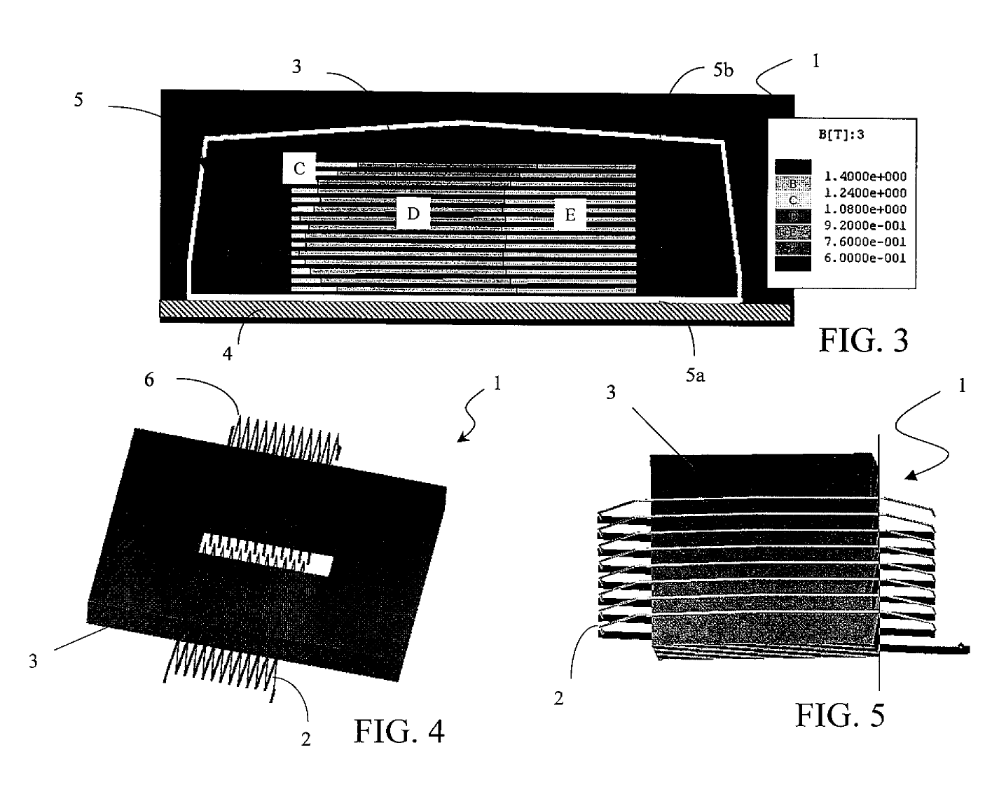

The magnetic field inside the multilayer ferromagnetic structure 2 thus obtained is schematically shown in FIG. 3, and it is on the order of 1 T with the highest current equal to 0.6 A and parasite resistance equal to 3.5 Ohm.

The inductive structure 1 includes the winding 2 equipped with a plurality of coils 5, each one having a first portion 5a, comprising for example a length portion D of a metallization line 5c realized on the package substrate 4, as well as a second portion 5b, made for example of a bonding wire 5d, joined to each other in a ring-like configuration to form the coil 5, as shown in FIG. 3. In particular the bonding wire 5d connects a first X1 and a second end X2 of the portion 5a of the metallization line 5c so as to form the coil 5.

Preferably, the multilayer ferromagnetic structure 3 is arranged above the package structure 4 so as to be contained inside the coil 5. In particular the multilayer ferromagnetic structure 3 is arranged above the metallization line 5c, inside the first and the second end X1 and X2 of the same, with the bonding wire 5d suitably passing above this structure 3 to connect the first and the second end X1 and X2.

It is to be noted that the winding is not a closed path, in other words if the ends X1 and X2 are interconnected by using the first metal level of the substrate, they are not interconnected through a bonding wire so that the current flows in the winding in a desired way.

Moreover, the multilayer ferromagnetic structure 2 is suitably coated, at least in correspondence with a lower face thereof, arranged next to the package substrate 4 and to an upper face thereof, arranged next to an apical point Y of the bonding wire 5d, by means of an electrically insulating glue layer so as not to create conductive short-circuits between the coils.

In a preferred embodiment of the integrated inductive structure 1 according to the invention, this electrically insulating glue layer is arranged on all the faces of the multilayer ferromagnetic structure 3. Preferably the entire multilayer ferromagnetic structure 2 is coated with an electrically insulating glue.

Advantageously, to implement the integrated inductor in a multichip device by means of the inductive structure 1, the rules for the positioning of the bondfingers (not shown since conventional) and of the bonding wires used for the realization of a generic multichip device are suitably respected, so as not to have any problems with short-circuits between the bonding wires in consequence of the resin injection and of the molding carried out on the multichip device itself.

Possibly, if the application requires a quality factor characteristic of the integrated inductor higher than the one that can be obtained with the configuration described with reference to FIG. 1A, it is possible to double the bonding wires, starting from each bondfinger so as to reduce the global resistance of the winding 2 by means of a parallel path of two bonding wires.

The integrated inductor structure described herein finds advantageous application, for example, in step-up voltage converters where it is used to carry out changes in an operative voltage. The sole limitations of the integrated inductor thus obtained for these applications are constituted by the characteristics of the ferromagnetic material used, and they are linked to the highest switch frequency of the magnetization of the material itself and to the saturation magnetic field.

The inductive structure 1 is also suitable for implementing a transformer, as schematically shown in FIG. 3. The transformer includes a multilayer ferromagnetic structure 2, which can be suitably realized on a package substrate of a multichip device when the transformer is integrated in such multichip device, whereon a first or primary winding 2 and a second or secondary winding 6 are arranged, both implemented as previously described and having pluralities of coils also implemented as already described.

In a way known to a technician of the field, the number of coils comprised in the primary 2 and secondary winding 6 enable dimensioning of the transformer obtained by means of the inductive structure 1 as desired. Also in this case, the multilayer ferromagnetic structure 2 has a closed configuration, substantially ring-like shaped, in particular with a rectangular plan-form shape and equipped with a central opening, also preferably rectangular.

Thus, it is possible to produce a transformer suitable for use in a package of a multichip device, in particular a stacked device or a SIP.

Considered the geometric characteristics of the bonding wire (which normally has a section equal to 25 μm) and the rules tidying the routing in the substrate of the multichip device, the transformer of the integrated inductive structure 1 can be used for frequencies higher than the tens of kHz.

By using bonding wires with greater sections, it is possible to operate the transformers at a lower frequency than the one indicated.

The integrated inductive structure 1 is also suitable for producing a sensor schematically shown in FIG. 5. In this case, the multilayer ferromagnetic structure 3 has a substantially bar-like shape, in particular squared, with the coils of the winding 2 wound thereon.

The sensor configuration shown in FIG. 5 can be used as a proximity sensor based on the magnetic field, a passage sensor, or also a position sensor to be applied to a stator or to a rotor of a robot motor.

In fact, by measuring the current induced in the sensor thus realized by the integrated inductive structure 1, the variation of the magnetic flux linked with its winding 2 can be determined.

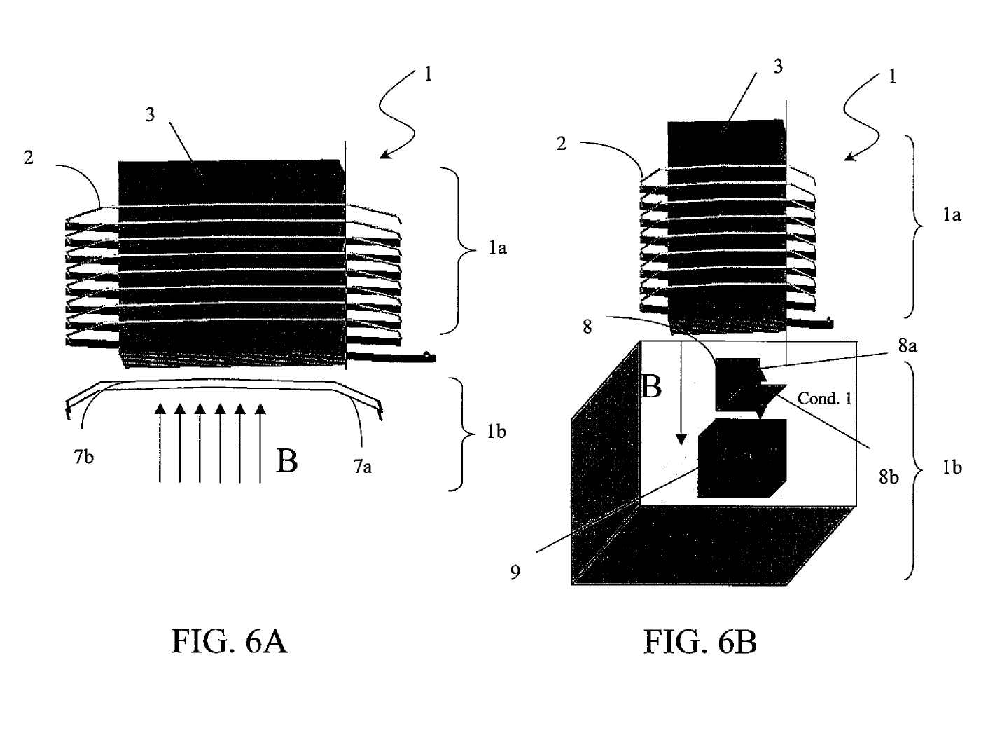

The integrated inductive structure 1 can be used for a relay, schematically shown in FIGS. 6A and 6B. The integrated inductive structure 1 implementing the relay includes, in this case, a first portion 1a configured as the sensor of FIG. 5 and having in turn a multilayer ferromagnetic structure 2 whereon a winding 2 is wound as well as a second portion 1b, in particular a triggering portion, substantially suitable to function as a switch.

In the example of FIG. 6A, the triggering portion 1b essentially includes a first bonding wire 7a ideally formed with material sensitive to a magnetic field, such as for example iron or nickel, as well as a further non-ferromagnetic wire 7b (shown in FIG. 6A by a second bonding wire 7b).

In this way, by applying a current onto the winding 2 of the first portion 1a, it is possible to generate a magnetic field B outside the multilayer ferromagnetic structure 3. If the first bonding wire 7a is placed inside this magnetic field B, it moves and it can thus can generate a contact with the other wire 7b.

It is however important to emphasize that in this case the use of the two different materials for the bonding wires (one being ferromagnetic, the other not) is to be provided. Moreover, the contact surface between the two wires could be reduced, implying quite a high parasite contact resistance.

In a further advantageous embodiment of the integrated inductive structure 1 suitable to implement a relay, schematically shown in FIG. 6B, the triggering portion 1b includes a first switch element 8 and a second switch element 9.

In particular, the first switch element 8 includes a mobile element able to create the electric contact with the second switch element 9. In the embodiment shown in FIG. 6B, the first switch element 8 is formed using a strip 8a of ferromagnetic material equipped with a metallic tongue 8b. When a magnetic field B is applied, a force is generated inside the triggering portion 1b that is able to move the metallic tongue 8b in the direction of the second switch element 9: it is thus possible to short-circuit the two switch elements 8 and 9 and to have through them a current flow.

Both of the switch elements 8 and 9 are glued with a conductive glue (or welded) on a pad of the package substrate of a multichip device with which the integrated inductive structure 1 suitable to implement the relay is integrated. In this way they are short-circuited with the relative connection. By inverting the direction of the current flowing in the winding 2 of the first portion 1a of the inductive structure 1 it is possible to move away the two switch element 8 and 9 and to ease the opening of the switch in the second portion 1b.

It is to be noted that for both the embodiments of the inductive structures 1 suitable to implement a relay, the triggering portion 1b includes a ferromagnetic contact that must be free to move. Therefore, the area wherein this inductive structure 1 is formed does not have to be covered by resin. The inductive structure 1 thus includes a protective plastic casing for the area of the mobile contact. In a preferred embodiment of the inductive structure 1, inside this protective area a void is created so as to avoid problems of oxidation of the metallic and ferromagnetic contacts.

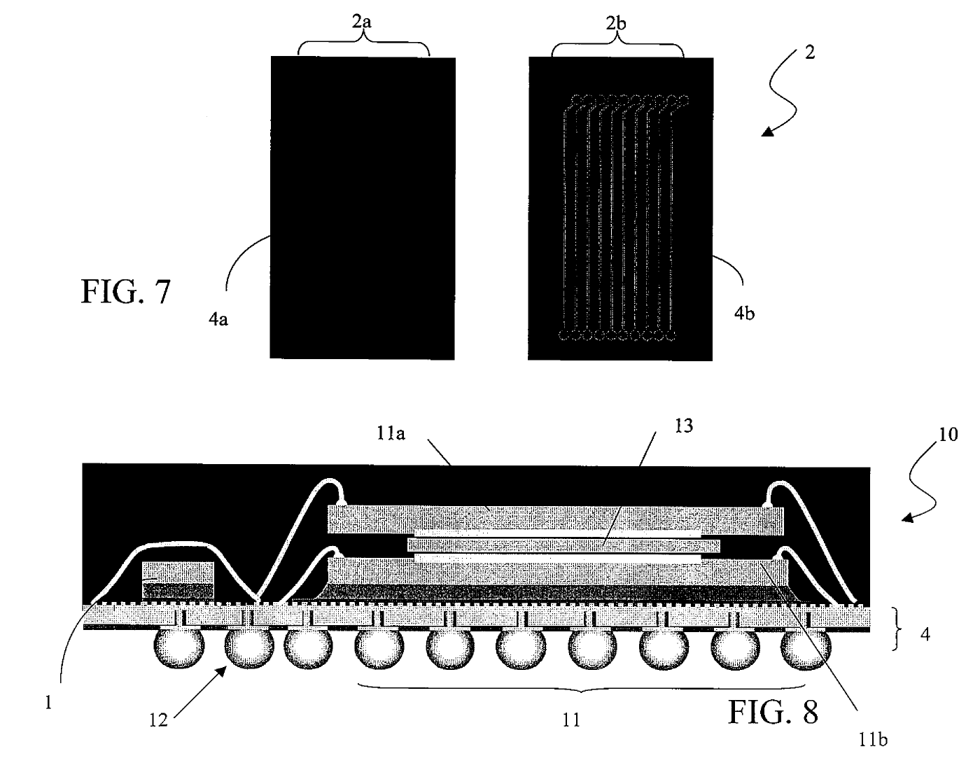

In a further embodiment, shown with reference to FIG. 7, the winding 2 is implemented without exploiting the bonding wires, but through suitable routing of a first and of a second plurality of tracks in different layers of the package substrate of the multichip device wherein the winding 2 is integrated. In particular, a first portion 2a of the winding 2 comprising this first plurality of tracks and is formed in a first layer 4a of the package substrate 4, and a second portion 2b comprising a second plurality of tracks is formed in a second layer 4b of the package substrate 4, suitable vias being provided for the contact of said pluralities of tracks.

It is also possible to interpose, between this first layer 4a and second layer 4b, a suitable ferromagnetic material for increasing the magnetic potentialities of the winding 2 thus obtained.

FIG. 8 schematically shows a section of a multichip device, in particular a SIP 10, having at least an integrated inductive structure 1 formed according to the disclosure herein, suitable to implement an inductor, a sensor, or a relay.

In particular, the SIP 10 includes the integrated inductive structure 1 formed next to a stack 11 of a first 11a and of a second chip 11b, mounted on a package substrate 4, which is equipped with a ball grid array 12, and possibly separated by an interposer 13.

The present disclosure also relates to a method for integrating an inductive structure 1 on a package substrate 4, in particular in a multichip device such as a stacked device or a SIP. The method includes the steps of:

providing a package substrate 4;

forming in this package substrate 4 at least one metallization line 5c;

integrating on the package substrate 4 at least one electronic device, in particular a chip stack 11.

Advantageously, the method also provides the steps of:

forming on this package substrate 4 an inductive structure 1 next to this chip stack 11.

In particular, this step of forming an integrated inductive structure 1 includes the steps of:

depositing a multilayer ferromagnetic structure 3 on this package substrate 4 next to this chip stack 11; and

forming at least one coil 5 of a winding 2 of this integrated inductive structure 1 by means of an electric connection of a portion 5a of this metallization line 5c.

In particular, the electric connection of a first end X1 and of a second end X2 of the portion 5a of the metallization line 5c is carried out by means of bonding above the multilayer ferromagnetic structure 3, as shown in FIGS. 1A and 2. In particular, a bonding wire 5d is connected to the first end X1 and to the second end X2 of the portion 5a of the metallization line 5c in a ring-like configuration to form the coil 5, as shown in FIG. 3. In particular the coil 5 includes a first portion corresponding to the portion 5a of the metallization line 5c and a second portion that includes the bonding wire 5d joined to each other to form a ring and thus a coil 5 of the winding 2.

In this method, it is possible to form a winding 2 having a plurality of coils 5 by using a plurality of metallization lines and bonding wires.

In this case, the method advantageously provides that this bonding step is performed simultaneously with at least one bonding step of the process flow suitable to form the chip stack 11.

Alternatively, this electric connection of a first end X1 and of a second end X2 of the portion 5a of the metallization line 5c is accomplished through routing of at least one further portion of a further or second metallization line formed in a second layer 4b of the package substrate 4 distinct from a first layer 4a of this package substrate 4 wherein the first metallization line 5c is formed.

Also in this case it is possible to implement a winding 2 having a plurality of coils 5 by means of a plurality of first and second metallization lines.

Advantageously, the method also provides that the deposition step of the multilayer ferromagnetic structure 3 of the package substrate 4 includes the steps of:

depositing a plurality of layers 3a of flat ferromagnetic material overlapped onto each other to form the multilayer ferromagnetic structure 3.

In a preferred embodiment, the method also provides that the deposition step of the multilayer ferromagnetic structure 3 on the package substrate 4 includes the steps of:

depositing a plurality of layers 3a of flat ferromagnetic material and a plurality of layers 3b of adhesive material, overlapped onto each other in an alternated way.

Advantageously, this deposition step of the multilayer ferromagnetic structure 3 on the package substrate 4 is performed simultaneously with at least one deposition step of at least one chip of the stack.

For example, a small block of ferromagnetic material being cut and already packed to form a multilayer material, can be treated in an identical way as the “dices”, i.e., it can be placed on the substrate with suitable “pick and place” machines.

Finally, the method includes, before the step of forming the winding 2, at least one coating step of the multilayer ferromagnetic structure 3 by means of an insulating layer, in particular an insulating glue layer.

In particular, this coating step provides a deposition of this insulating layer on a lower face of the multilayer ferromagnetic structure 2, arranged next to the package substrate 4 and on an upper face thereof, opposite the lower face. Suitably, this insulating layer is deposited on all the faces of the multilayer ferromagnetic structure 2.

In substance, the embodiments of inductive structure 1 described herein enable production of an inductor, a transformer, a sensor, and a relay inside a package of an electronic device.

Thus, by using the inductive structure 1 described herein, it is possible to increase the potentiality of the systems that can be formed in a package, for example by allowing the insertion inside the package of inductors with considerable inductance values suitable for particular applications and with saturation currents close to one Ampere, without interfering in a significant way with the rest of the system integrated therewith.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An inductive structure, comprising at least one winding including at least one coil and developed around a ferromagnetic core, the inductive structure integrated in a package of an electronic device, the ferromagnetic core formed by means of a ferromagnetic structure arranged above a substrate of the package.

2. The inductive structure according to claim 1 wherein said ferromagnetic structure comprises multiple layers.

3. The inductive structure according to claim 2 wherein said multilayer ferromagnetic structure comprises a plurality of layers of flat ferromagnetic material overlapped onto each other.

4. The inductive structure according to claim 3 wherein said multilayer ferromagnetic structure further comprises a plurality of layers of insulating material alternated to said plurality of layers of flat ferromagnetic material.

5. The inductive structure according to claim 4 wherein said layers of insulating material are realized in an adhesive material.

6. The inductive structure according to claim 1 wherein said multilayer ferromagnetic structure has a closed configuration that is substantially ring-like shaped.

7. The inductive structure according to claim 1 wherein said at least one coil comprises a first portion that includes a first portion of a metallization line realized in said package substrate, as well as a second portion, said second portion connecting a first end and a second end of said first portion to form coils of a continuous winding.

8. The inductive structure according to claim 7 wherein said second portion comprises a bonding wire.

9. The inductive structure according to claim 7 wherein said second portion comprises a portion of a further metallization line realized in a layer of said package substrate that is distinct from other layers of said package substrate wherein said metallization line is realized.

10. The inductive structure according to claim 9, comprising contact vias of said metallization line and of said further metallization line.

11. The inductive structure according to claim 1, comprising an insulating coating layer for said multilayer ferromagnetic structure.

12. The inductive structure according to claim 11 wherein said insulating coating layer coats said multilayer ferromagnetic structure in correspondence with a lower face thereof, arranged next to said package substrate, and to an upper face thereof that is opposite to said lower face.

13. The inductive structure according to claim 11 wherein said insulating coating layer coats said multilayer ferromagnetic structure in correspondence with all the faces thereof.

14. The inductive structure according to claim 11 wherein said insulating coating layer comprises an electrically insulating glue layer.

15. The inductive structure according to claim 1 wherein it comprises a transformer that includes a further winding arranged above said multilayer ferromagnetic structure.

16. The inductive structure according to claim 15 wherein said multilayer ferromagnetic structure has a closed configuration that is substantially ring-like in shape.

17. The inductive structure according to claim 1 wherein it comprises a sensor and said multilayer ferromagnetic structure has a substantially bar-like shape.

18. The inductive structure according to claim 1 wherein it comprises a relay that includes a first portion comprising said multilayer ferromagnetic structure whereon said winding is wound and a second triggering portion suitable to realize a switch.

19. The inductive structure according to claim 18 wherein said second triggering portion comprises at least a first wire comprising with a material sensitive to the magnetic field and with a second wire arranged next to this first wire, placed in turn inside a magnetic field generated by said first portion and able to move so as to contact said second wire.

20. The inductive structure according to claim 19 wherein said second wire comprises in a non-ferromagnetic material.

21. The inductive structure according to claim 19 wherein said first wire comprises a bonding wire.

22. The inductive structure according to claim 19 wherein said second wire comprises a bonding wire.

23. The inductive structure according to claim 19 wherein said first wire comprises a strip of ferromagnetic material equipped with a metallic tongue configured to move in a direction towards, and respectively away from, said second conductor.

24. The inductive structure according to claim 23 wherein said first and second wire are glued with a conductive glue or welded on a pad of said package substrate.

25. The inductive structure according to claim 18 wherein said second triggering portion comprises a protective plastic casing.

26. The inductive structure according to claim 25 wherein a void is created in said protective plastic casing.

27. The inductive structure according to claim 1 wherein said electronic device comprises a multichip device.

28. A method for integrating an inductive structure on a package substrate, comprising the steps of:
providing a package substrate;
forming in said package substrate at least one metallization line;
integrating on said package substrate at least one electronic device;
forming on said package substrate, an inductive structure next to said electronic device, further comprising the steps of:
depositing a multilayer ferromagnetic structure on said package substrate next to said electronic device; and
forming at least one coil of a winding of said integrated inductive structure by means of an electric connection of a portion of said metallization line.

29. The method according to claim 28 wherein said electric connection step of a portion of said metallization line comprises a bonding step for electrically connecting a first and a second end of one of said portions of said metallization line, said bonding step carried out above said multilayer ferromagnetic structure.

30. The method according to claim 29 wherein said bonding step is performed simultaneously with at least one bonding step of a process flow suitable for forming said electronic device.

31. The method according to claim 28 wherein said electric connection step of a portion of said metallization line comprises a routing step of at least a further portion of a further metallization line formed in another layer of said package substrate distinct from a first layer of said package substrate wherein said metallization line is formed.

32. The method according to claim 28 wherein said deposition step of said multilayer ferromagnetic structure on said package substrate comprises the step of:
depositing a plurality of layers of flat ferromagnetic material overlapped onto each other.

33. The method according to claim 28 wherein said deposition step of said multilayer ferromagnetic structure on said package substrate comprises the steps of:
depositing a plurality of layers of flat ferromagnetic material and a plurality of layers of adhesive material, overlapped onto each other in an alternated way.

34. The method according to claim 28 wherein said deposition step of said multilayer ferromagnetic structure on said package substrate can be realized simultaneously with at least one realization step of said electronic device.

35. The method according to claim 28 wherein it further comprises a coating step of said multilayer ferromagnetic structure by means of an insulating layer.

36. The method according to claim 35 wherein said coating step involves a lower face of said multilayer ferromagnetic structure arranged next to said package substrate and an upper face thereof that is opposite to said lower face.

37. The method according to claim 35 wherein said coating step involves all the faces of said multilayer ferromagnetic structure.

38. The method according to claim 35 wherein said electronic device is a multichip device.

39. A circuit, comprising:
a ferromagnetic core formed above a substrate of an integrated electronic device from a plurality of ferromagnetic layers disposed between layers of adhesive material in an integrated structure; and
at least one coil of electrically conductive material formed around the ferromagnetic core.

40. The circuit of claim 39 wherein the ferromagnetic core comprises a substantially ring-like closed ferromagnetic structure.

41. The circuit of claim 40, further comprising an insulating coating for the ferromagnetic core.

42. The circuit of claim 39 wherein the coil comprises a first portion having a metallization line formed in a substrate of the package and a second portion connecting first and second ends of the first portion to form a continuous winding of the coil.

43. The circuit of claim 42 wherein the second portion of the metallization line comprises a bonding wire.

44. The circuit of claim 39, further comprising a winding of electrically conductive material associated with the ferromagnetic core, the winding cooperating with the coil to form a transformer.

45. The circuit of claim 39, further comprising a switch comprising a strip of ferromagnetic material equipped with a metallic tongue configured to move in a direction toward, and respectively away from, a second conductor in response to a magnetic field generated by the coil.
